(19) United States
(12) Patent Application Publication
(10) Pub. No.: US 2024/0177298 A1
(43) Pub. Date: May 30, 2024

(54) SYSTEM AND METHOD FOR ANALYZING SYSTEM HEALTH OF INDIVIDUAL ELECTRONIC COMPONENTS USING IMAGE MAPPING

(71) Applicant: BANK OF AMERICA CORPORATION, Charlotte, NC (US)

(72) Inventors: Maharaj Mukherjee, Poughkeepsie, NY (US); Carl M. Benda, Kannapolis, NC (US); Elvis Nyamwange, Little Elm, TX (US); Utkarsh Raj, Charlotte, NC (US); Suman Roy Choudhury, Berkeley Heights, NJ (US); Vidya Srikanth, Sunnyvale, CA (US); Colin Murphy, Charlotte, NC (US)

(73) Assignee: BANK OF AMERICA CORPORATION, Charlotte, NC (US)

(21) Appl. No.: 18/522,864

(22) Filed: Nov. 29, 2023

Related U.S. Application Data
(60) Provisional application No. 63/428,939, filed on Nov. 30, 2022.

(51) Int. Cl. G06T 7/00

(52) U.S. Cl. CPC G06T 7/001; G06T 2207/30141

(57) ABSTRACT

Systems, computer program products, and methods are described herein for analyzing system health of individual electronic components using image mapping. The method includes receiving a component health image for a component based on an execution of a process. The method also includes comparing the component health image based on the execution of the process to previous component health image(s) for the component based on one or more previous executions of the process The method further includes determining a component health image similarity score based on the comparison of the component health image to the one or more previous component health images for the component. The method still further includes determining a component health action based on the component health image similarity score. The component health action includes causing a transmission of an alert in an instance in which the component health image similarity score is outside of a threshold range.

### CROSS-REFERENCE TO RELATED APPLICATIONS

This application claims the benefit of U.S. Provisional Patent Application Ser. No. 63/428,939, filed Nov. 30, 2022, entitled “System And Method For Analyzing System Health Of Individual Electronic Components Using Image Mapping”, the entirety of which is incorporated herein by reference.

### TECHNOLOGICAL FIELD

Example embodiments of the present disclosure relate generally to analyzing system health of individual electronic components and, more particularly, to analyzing system health of individual electronic components using image mapping.

### BACKGROUND

Processes often require usage of multiple system components, including both software application components and hardware components. Therefore, all of the components used during a process need to be functional during execution of the process. Through applied effort, ingenuity, and innovation, many of these identified problems have been solved by developing solutions that are included in embodiments of the present disclosure, many examples of which are described in detail herein.

### SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

In an example embodiment, a system for analyzing system health of individual electronic components using image mapping is provided. The system includes at least one non-transitory storage device and at least one processing device coupled to the at least one non-transitory storage device. The at least one processing device is configured to receive a component health image for a component based on an execution of a process. The at least one processing device is further configured to compare the component health image based on the execution of the process to one or more previous component health images for the component based on one or more previous executions of the process. The at least one processing device is further configured to determine a component health image similarity score based on the comparison of the component health image based on the execution of the process to the one or more previous component health images for the component based on one or more previous executions of the process. The at least one processing device is still further configured to determine a component health action based on the component health image similarity score. The component health action includes causing a transmission of an alert in an instance in which the component health image similarity score is outside of a threshold range.

In various embodiments, the comparison of the component health image based on the execution of the process to the one or more previous component health images for the component based on one or more previous executions of the process includes comparing the component health image to an average component health image based at least partially on the one or more previous component health images.

In various embodiments, the component health image similarity score is produced via a standard distribution of the one or more previous component health images for the component. In various embodiments, the at least one processing device is configured to modify at least one of the one or more previous component health images for the component to conform to a format of the component health image of the component.

In various embodiments, the at least one processing device is configured to identify at least one of the one or more previous component health images for the component based on a similarity to the component health image. In various embodiments, the at least one processing device is configured to generate an array of one or more component metric images and the array of the one or more component metric images is used to generate at least one of the one or more previous component health images for the component.

In various embodiments, the one or more previous component health images for the component are selected based on at least a partial similarity to the component health image. In various embodiments, the at least one processing device is configured to generate the component health image for the component based on the execution of the process

In another example embodiment, a computer program product for analyzing system health of individual electronic components using image mapping is provided. The computer program product includes at least one non-transitory computer-readable medium having computer-readable program code portions embodied therein. The computer-readable program code portions include an executable portion configured to receive a component health image for a component based on an execution of a process. The computer-readable program code portions also include an executable portion configured to compare the component health image based on the execution of the process to one or more previous component health images for the component based on one or more previous executions of the process. The computer-readable program code portions further include an executable portion configured to determine a component health image similarity score based on the comparison of the component health image based on the execution of the process to the one or more previous component health images for the component based on one or more previous executions of the process. The computer-readable program code portions still further include an executable portion configured to determine a component health action based on the component health image similarity score. The component health action includes causing a transmission of an alert in an instance in which the component health image similarity score is outside of a threshold range.

In various embodiments, the comparison of the component health image based on the execution of the process to the one or more previous component health images for the component based on one or more previous executions of the process includes comparing the component health image to an average component health image based at least partially on the one or more previous component health images.

In various embodiments, the component health image similarity score is produced via a standard distribution of the one or more previous component health images for the component. In various embodiments, the computer program product further includes an executable portion configured to modify at least one of the one or more previous component health images for the component to conform to a format of the component health image of the component.

In various embodiments, the computer program product further includes an executable portion configured to identify at least one of the one or more previous component health images for the component based on a similarity to the component health image. In various embodiments, the computer program product further includes an executable portion configured to generate an array of one or more component metric images and the array of the one or more component metric images is used to generate at least one of the one or more previous component health images for the component.

In various embodiments, the one or more previous component health images for the component are selected based on at least a partial similarity to the component health image. In various embodiments, the computer program product further includes an executable portion configured to generating the component health image for the component based on the execution of the process

In still another example embodiment, a computer-implemented method for analyzing system health of individual electronic components using image mapping is provided. The method includes receiving a component health image for a component based on an execution of a process. The method also includes comparing the component health image based on the execution of the process to one or more previous component health images for the component based on one or more previous executions of the process. The method further includes determining a component health image similarity score based on the comparison of the component health image based on the execution of the process to the one or more previous component health images for the component based on one or more previous executions of the process. The method still further includes determining a component health action based on the component health image similarity score. The component health action includes causing a transmission of an alert in an instance in which the component health image similarity score is outside of a threshold range.

In various embodiments, the comparison of the component health image based on the execution of the process to the one or more previous component health images for the component based on one or more previous executions of the process includes comparing the component health image to an average component health image based at least partially on the one or more previous component health images.

In various embodiments, the component health image similarity score is produced via a standard distribution of the one or more previous component health images for the component. In various embodiments, the method also includes modifying at least one of the one or more previous component health images for the component to conform to a format of the component health image of the component.

In various embodiments, the method further includes identifying at least one of the one or more previous component health images for the component based on a similarity to the component health image. In various embodiments, the method further includes generating an array of one or more component metric images and the array of the one or more component metric images is used to generate at least one of the one or more previous component health images for the component.

In various embodiments, the method also includes generating the component health image for the component based on the execution of the process.

The features, functions, and advantages that have been discussed may be achieved independently in various embodiments of the present disclosure or may be combined with yet other embodiments, further details of which can be seen with reference to the following description and drawings.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIGS. 1A-1C illustrates technical components of an example distributed computing environment for analyzing system health of individual electronic components using image mapping and/or relational graphs, in accordance with various embodiments of the present disclosure;

FIG. 2 illustrates an example machine learning (ML) subsystem architecture, in accordance with various embodiments of the present disclosure;

FIG. 3 illustrates a process flow for analyzing system health of individual electronic components using component relational graphs, in accordance with various embodiments of the present disclosure;

FIG. 4 illustrates an example system with a plurality of interconnected components used in one or more processes, in accordance with various embodiments of the present disclosure;

FIG. 5 illustrates a flow diagram for generating a component knowledge graph for a process, in accordance with various embodiments of the present disclosure;

FIG. 6 illustrates the component usage chart for a process, in accordance with various embodiments of the present disclosure;

FIG. 7 illustrates a visual representation of a directional flow of the component knowledge graph, in accordance with various embodiments of the present disclosure;

FIG. 8 illustrate a plurality of component health images for multiple components of a system, in accordance with various embodiments of the present disclosure;

FIG. 9A illustrates example previous component health images used for image mapping, in accordance with various embodiments of the present disclosure;

FIG. 9B illustrates an example component health image that can be compared to the previous component health images of FIG. 9A, in accordance with various embodiments of the present disclosure; and

FIG. 10 illustrates a process flow for analyzing system health of individual electronic components using image mapping, in accordance with various embodiments of the present disclosure.

### DETAILED DESCRIPTION

Embodiments of the present disclosure will now be described more fully hereinafter with reference to the accompanying drawings, in which some, but not all, embodiments of the disclosure are shown. Indeed, the various inventions may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure, and positioning (distal phalanges, intermediate phalanges, proximal phalanges, and the like)), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

Processes often require usage of multiple system components, including both software application components and hardware components. Therefore, all of the components used during a process need to be functional during execution of the process. Being able to determine relationships between components during a process can allow for improved system efficiency as effects of component health on process execution can be determined. However, typical relational graphs are completed on a system level, which does not allow for relationships to be determined on a process by process basis.

Various embodiments of the present disclosure provide a system for analyzing system health of individual electronic components using image mapping. The system creates a component knowledge graph for an individual process. For each process, the system may use historical data, telemetry data, and/or simulated data to generate a component knowledge graph. The component knowledge graph includes nodes representing each component used during a process. From the component knowledge graph, a component health rating can be determined. A component health image can be generated based on the component health rating for each component used during the process.

The component health image may then be compared to previous component health images for the component to determine an anomaly with the component. To do this, one or more component health images for the component are retrieved from a database. The component health image for the current execution of the process is then compared to the one or more component health images to determine a component health image similarity score of the component health image. In an instance in which the component health image similarity score is outside of a threshold range of similarity, the component health image may be anomalous, and an anomaly alert may be provided by the system.

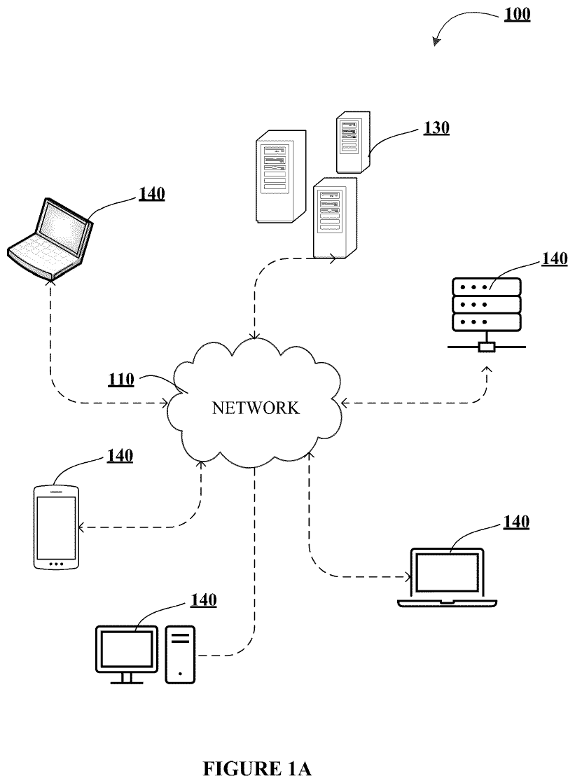

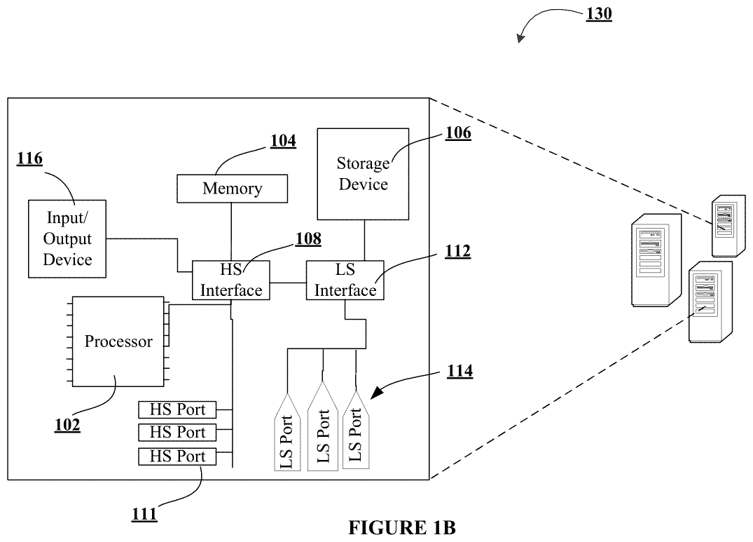

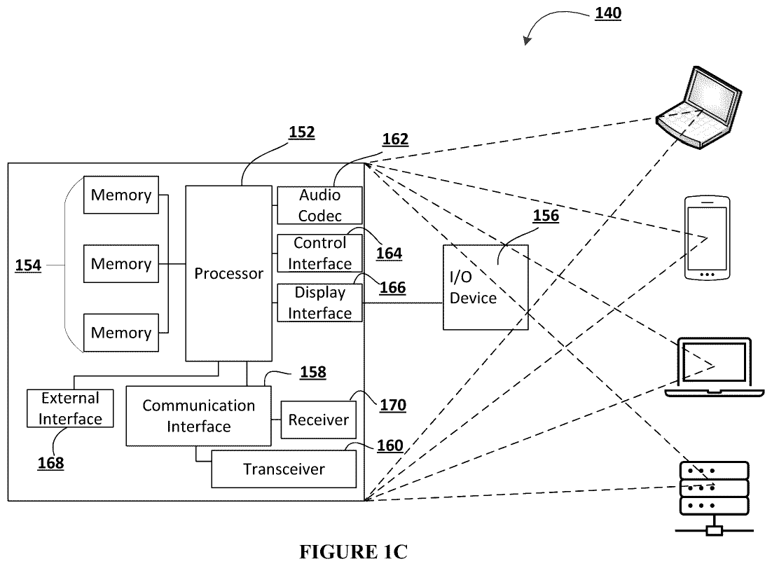

FIGS. 1A-1C illustrate technical components of an example distributed computing environment for analyzing system health of individual electronic components using component relational graphs, in accordance with an embodiment of the disclosure. As shown in FIG. 1A, the distributed computing environment 100 contemplated herein may include a system 130 (i.e., an authentication credential verification), an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be example only, and are not meant to limit implementations of the disclosure described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an example component-level structure of the system 130, in accordance with an embodiment of the disclosure. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low-speed expansion port 114 (shown as “LS Port”) and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 106, or memory on processor 102.

The high-speed interface 108 manages bandwidth-intensive operations for the system 130, while the low-speed interface 112 manages lower bandwidth-intensive operations. Such allocation of functions is example only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an example component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a micro-drive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single in Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

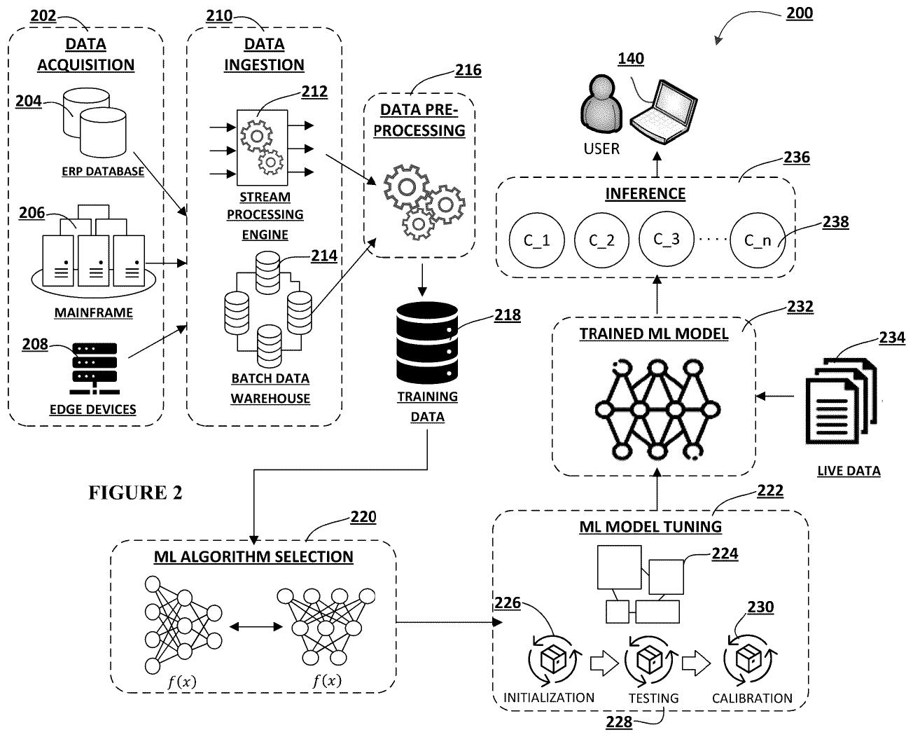

FIG. 2 illustrates an example machine learning (ML) subsystem architecture 200, in accordance with an embodiment of the present disclosure. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 210, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is example and that other embodiments may vary. As another example, in some embodiments, the machine learning subsystem 200 may include more, fewer, or different components.

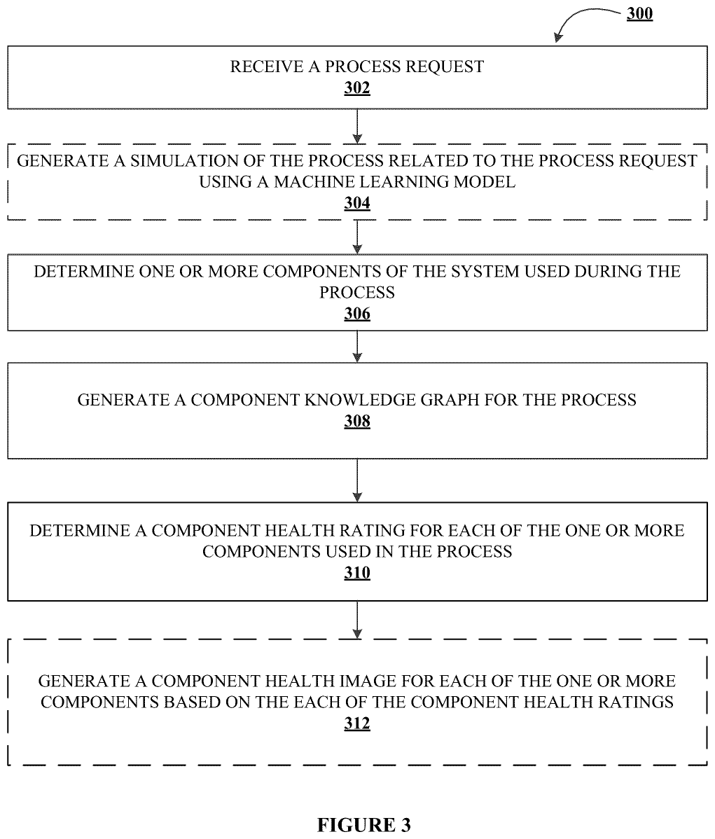

FIG. 3 is a flow chart 300 that illustrates another example method of analyzing system health of individual electronic components using component relational graphs. The method may be carried out by various components of the distributed computing environment 100 discussed herein (e.g., the system 130, one or more end-point devices 140, etc.). An example system may include at least one non-transitory storage device and at least one processing device coupled to the at least one non-transitory storage device. In such an embodiment, the at least one processing device is configured to carry out the method discussed herein.

Referring now to Block 302 of FIG. 3, the method includes receiving a process request. The process request is a request to execute a process. The process may be an application and/or program relating to an application. The process request may be received from a user input on a user device (e.g., end-point device 140) associated with a user (e.g., a user may click a program for execution).

Referring now to optional Block 304 of FIG. 3, the method includes generating a simulation of the process related to the process request using a machine learning model. The machine learning model may be trained using historical data (e.g., from previous process execution). Additionally, the machine learning model may be updated by subsequent process execution. The simulation of the process may allow the usage of each component to be predicted without having to actually execute the process (e.g., conserving processing capacity).

Referring now to Block 306 of FIG. 3, the method includes determining one or more components of the system used during the process. The one or more components of the system used during the process may be determined via historical data (e.g., past process execution), telemetry data (e.g., real-time processing data), and/or simulation data (e.g., generated using a machine learning model). The one or more components may include software application components and/or hardware components that are connected to the system. During a process execution, various software applications may be engaged in order to execute the process and various hardware components may be used to execute the process.

Referring now to Block 308 of FIG. 3, the method includes generating a component knowledge graph for the process. The component knowledge graph indicates the usage of various components for a specific process. An individual component knowledge graph may be generated for each individual process. The component knowledge Graph is a representation of inter-relationships and inter-dependencies of different components during the process. Component knowledge graph can be used for storing various component information, such as current component health. The component knowledge may be configured to be queried (e.g., using SQL or similar languages).

The component knowledge graph includes one or more nodes corresponding to each of one or more components used during the process. In various embodiments, each component that is used by a given process is represented in the component knowledge graph as a node. The edges of the component knowledge graph may indicate the interactions between said components during the process. For example, an edge from one node to another may indicate that a given component usage causes the usage of another usage during the process.

The component knowledge graph may be generated using historical data (e.g., past process execution), telemetry data (e.g., real-time processing data), and/or simulation data (e.g., generated using a machine learning model). To generate the component knowledge graph, the components used in a process are identified.

In an instance in which historical data is used to generate the component knowledge graph, the historical data may include previous process executions sent within a given time interval. In such an instance, various component usage can be determined (e.g., CPU load >X and/or Memory load >Y).

In an instance in which telemetry data is used to generate the component knowledge graph, the telemetry data may include real-time or near real-time streaming data relating to various components during execution of the process. The telemetry data may be dynamic (e.g., changing during the execution of the process). In some instances, the telemetry data may be received during the process execution. Alternatively, the telemetry data may be received shortly after the process execution is completed (e.g., the telemetry data for the entire process may be received after the process is completed). In some embodiments, the telemetry data may be used to dynamically update the component knowledge graph. For example, if a component is being used in real-time that was not originally in the component knowledge graph, a node may be added to the component knowledge graph that represents the given component.

In an instance in which simulated data is used to generate the component knowledge graph, the simulated data may include simulated data generated via the machine learning models discussed herein. For example, the machine learning models simulate the execution of the process allowing for simulated data without requiring resources necessary to actually carry out the process.

In various embodiments, the component knowledge graph may be used to determined one or more critical paths of a process. The critical paths may be used to determine one or more components that are important to a process (e.g., may be used to determine which components need to have increased maintenance or service to avoid outages).

In some embodiments, the critical path of a process may be determined using one or more graph metrics calculated for different paths along the component knowledge graph. Example metrics that may be used may include average out-degree of nodes in the path (e.g., based on the number of hyperlinks on a page), average number of times a link is traversed (e.g., traversing the same link more than a typical user may indicate that a user is lost), amount of detour for the navigation (e.g., ratio of the current path length to the shortest path from the start node to the current node), relative mean distance from root (e.g., average distance from the root node to every other node in the path), connection ratios (e.g., ratio of all the edges used in the path to the total number of edges connecting the nodes in the path), shortest path from root to target, amount of backtracking (e.g., returning to previously traversed node), distance from current node to expected target, and/or clickstream compactness (e.g., how much of the graph is traversed).

Referring now to Block 310 of FIG. 3, the method includes determining a component health rating for each of the one or more components used in the process. The component health rating may be based on one or more health rating for the individual component type (e.g., different components may have different component metrics, such as percentage of total usage capacity, component heat, etc.). The component health rating may be a numerical value (e.g., compared to a standardized metric). For example, the component heat may be compared to the standard heat of a given component and/or a maximum heat of the component.

The component health rating may also be a comparison to other similar components in the system. For example, a first software application usage may be compared to the usage of a second software application. In such an embodiment, the component health rating may be used to determine the most important components for a process or may also determine one or more components that are being overused during a process (e.g., indicating another component may be able to share the usage).

Referring now to optional Block 312 of FIG. 3, the method includes generating a component health image for each of the one or more components based on the each of the component health ratings. In various embodiments, the component health image may be a visual representation of the component health rating for the given component. For example, the component health image may be one of three colors (e.g., green, yellow, and red), in which the green indicates a high component health image (e.g., good health), yellow indicates a mid-level component health image (e.g., average health that may be problematic), and red indicates a low component health image (e.g., bad health that may indicate changes to a process and/or component may be needed to maintain system stability). While the previous example includes three color indicators, any number of colors or other indicator types may be used (e.g., could be a binary indicator with one color indicating good health and another color indicating bad health). The determination of the component health image may be based on a threshold component health rating that the component health rating for the given component is compared. In an instance in which the component health rating is above the threshold component health rating, the component may be considered in “good” health.

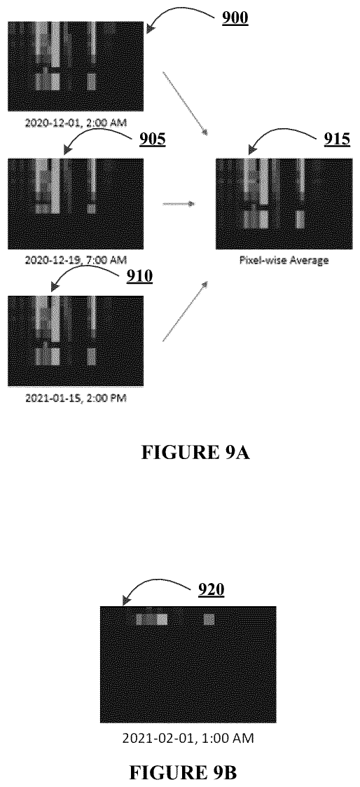

In various embodiments, the component health image may include a plurality of visual indictors for different capabilities of the component. For example, a portion of the component health image may correspond to the component heat of the component and another portion of the component health image may correspond to the usage percentage of the component. In various embodiments, the component health image for each of the one or more components comprise a heatmap indicating a usage of the component during execution of the process. Example component health images with heatmaps are shown in FIG. 9.

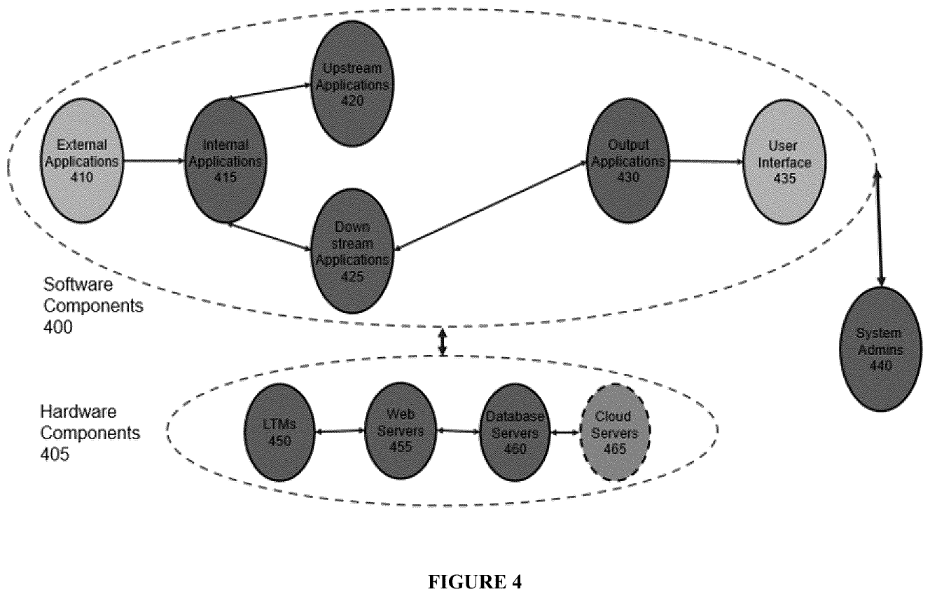

FIG. 4 illustrates an example system with a plurality of interconnected components used in one or more processes in accordance with various embodiments of the present disclosure. As shown, a system may include both software components 400 and hardware components 405. Example software components include external application 410, internal application 415, upstream applications 420, downstream applications 425, output applications 430, and software relating to rendering a user interface 435. A user interface 435 may be provided that can be interacted by a user (e.g., system admin 440). Each of the software components 400 may have different usages during a given process.

Example hardware components 405 include hardware components (e.g., processors, memory, etc.) of local traffic managers (LTMs) 450, web servers 455, database services 460 and cloud servers 465. Each of the software components 400 may have different usages during a given process. As discussed in reference to FIG. 3 above, each component (e.g., software components 400 and/or hardware components 405) may be represented by a node in the component knowledge graph. Additionally, the arrows shown in FIG. 4 may also correspond to edges in the component knowledge graph (e.g., indicating communication between nodes).

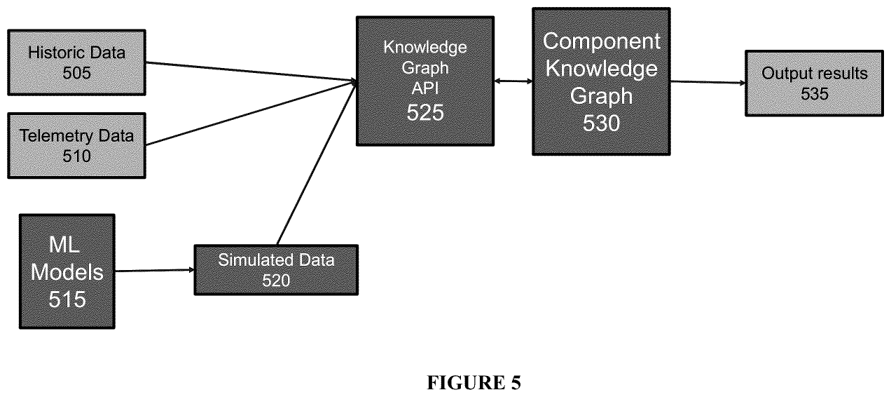

FIG. 5 illustrates a flow diagram for generating a component knowledge graph for a process in accordance with various embodiments of the present disclosure. As shown, a knowledge graph API 525 may be used to produce a component knowledge graph 530. To produce a component knowledge graph 530, the knowledge graph API 525 may receive historic data 505, telemetry data 510 (e.g., real-time data), and/or simulated data 520 (e.g., simulated data can be produced by one or more machine learning models 515).

Upon creation of a component knowledge graph 530, various output results 535 may be produced, such as component health ratings, component health images, critical path information, and/or the like. The knowledge graph API 525 may be used to produce multiple component knowledge graphs for multiple different processes.

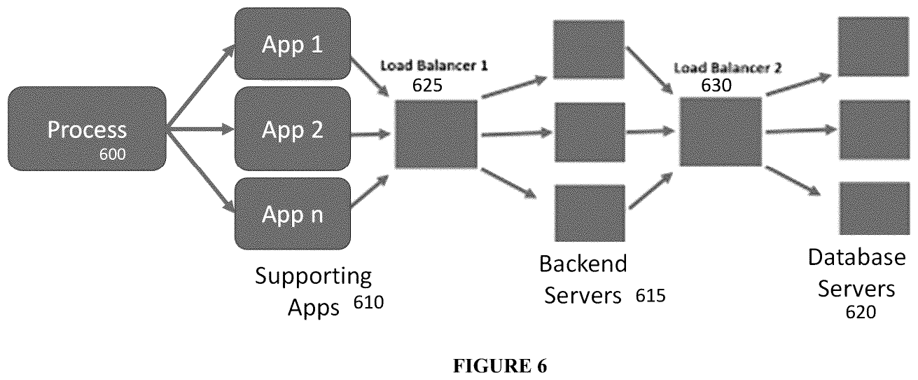

FIG. 6 illustrates the component usage chart for a process in accordance with various embodiments of the present disclosure. Various components used during a process 600 may include supporting applications 610 (e.g., applications used during a process), backend server components 615, database server components 620, and one or more load balancers between each of the levels (e.g., load balancer 1 625 between the supporting applications 610 and the backend server components 615, and load balancer 2 630 between the backend server components 615 and the database server components 620). Each of the individual boxes shown in FIG. 6 may have an individual component health rating and subsequently component health image.

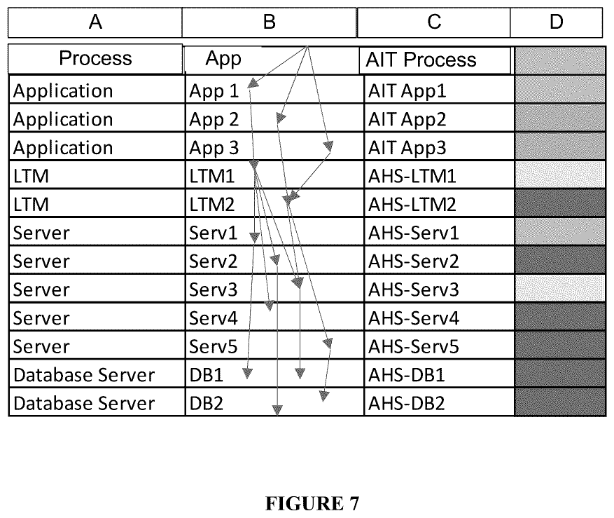

FIG. 7 illustrates a visual representation of a directional flow of the component knowledge graph in accordance with various embodiments of the present disclosure. As shown, column A, various components are shown that are used during a process. The components include applications, LTMs, servers, and database servers that are used during a process. As shown by the arrows in column B, each of the components shown are used during the process. Column C illustrates various component identifiers. Column D illustrates an example component health image for each of the components As shown, the green shaded boxes indicate good health, yellow indicates warning of the component health, and orange indicates a higher level of warning for component health.

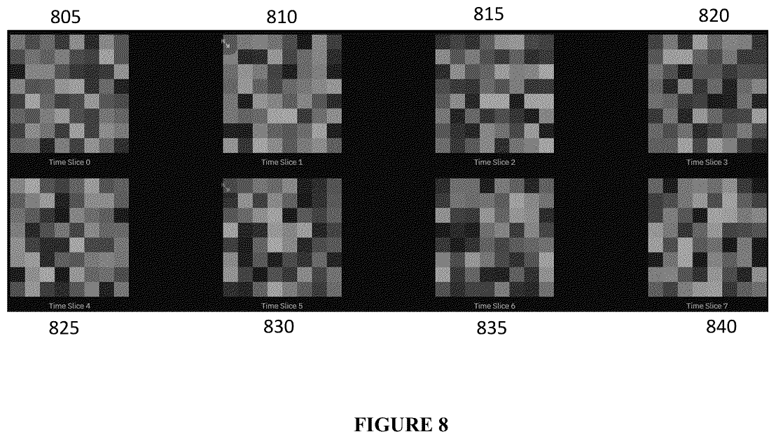

FIG. 8 illustrate a plurality of component health images for multiple components of a system in accordance with various embodiments of the present disclosure. The component health images 805, 810, 815, 820, 825, 830, 835, and 840 may each correspond to a different component of the system. The rows of each component health image may correspond to a different process (e.g., a component health image may be generated using multiple component knowledge graphs for multiple processes). Additionally, each of the columns may be various component metric during each process (e.g., component usage, component heat, etc.). The color within each pixel may be a heatmap that indicates the metric value (e.g., green may indicate saturation and blue may indicate idle). Various other component health images may be produced using the component knowledge graph(s) discussed herein.

FIG. 9A illustrates example previous component health images used for image mapping in accordance with various embodiments of the present disclosure. As shown, the previous component health images may be multiple component health images from past executions of a process. As shown, the first previous component health image 900 was captured at 2:00 AM on 12-01-2020; the second previous component health images 905 was captured at 7:00 AM on 12-19-2020; and the third previous component health images 910 was captured at 2:00 PM on 01-15-2021. Each of the previous component health images 900, 905, 910 may be combined to create an averaged previous component health image 915. As such, the combination of the previous component health images can be captured in a singular combined previous component health image 915. The combination may be a pixel-wise average. Additionally, the metrics illustrated in each of the previous component health images 900, 905, 910 may be used to determine the combined previous component health images 915 (e.g., the metrics for each previous component health image may be averaged together to create a metric used to create the combined previous component health image 915).

While FIG. 9A illustrates three previous component health images, any number of previous component health images may be used to generate a combined previous component health image. For example, the combined previous component health image may be a running average that is continually updated. Additionally, the number of previous component health images used may increase the dependability of the combined previous component health images. For example, in an instance in which a larger number of previous component health images that are known to be functioning correct, the combined previous component health image may be more dependable. Additionally, any anomalous previous component health images may not interfere with the function of the system, as the combined previous component health image would be more resistant to outliers.

FIG. 9B illustrates an example component health image 920 that can be compared to the previous component health images of FIG. 9B. The comparison may be to one or more of the individual previous component health images (e.g., first previous component health image 900, second previous component health image 905, or third previous component health image 910). Additionally or alternatively, the comparison may be to the combined previous component health image 915. As shown, the component health image 920 of FIG. 9B was captured at 1:00 AM on 02-21-2021 (e.g., after the previous component health images of FIG. 9A). Additionally, after comparison, the component health image 920 may be used to generate subsequent combined previous health images and/or update existing combined previous health image.

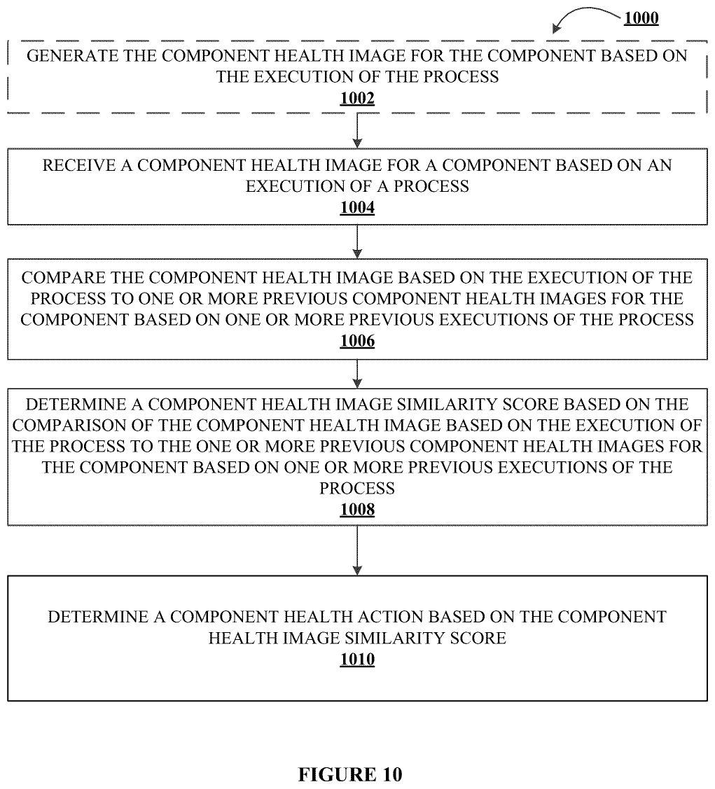

FIG. 10 is a flow chart 1000 that illustrates another example method of analyzing system health of individual electronic components using image mapping. The method may be carried out by various components of the distributed computing environment 100 discussed herein (e.g., the system 130, one or more end-point devices 140, etc.). An example system may include at least one non-transitory storage device and at least one processing device coupled to the at least one non-transitory storage device. In such an embodiment, the at least one processing device is configured to carry out the method discussed herein.

Referring now to optional Block 1002 of FIG. 10, the method includes generating the component health image for the component based on the execution of the process. The component health image may be generated using one or more of the processes discussed in reference to FIG. 3 above.

Referring now to Block 1004 of FIG. 10, the method includes receiving a component health image for a component based on an execution of a process. The component health image for the component may be received by the system either upon generation or from a database or the like. The component health image may visually illustrate one or more metrics relating to the component during the execution of the process. The component health image may be time-stamped.

Referring now to Block 1006 of FIG. 10, the method includes comparing the component health image based on the execution of the process to one or more previous component health images for the component based on one or more previous executions of the process. The comparison of the component health image based on the execution of the process to the one or more previous component health images for the component based on one or more previous executions of the process may include comparing the component health image to a combined component health image (e.g., an averaged version of multiple previous component health images). An example combined component health image 915 is shown in FIG. 9A. The combined previous health image may be a pixel-wise average of two or more previous health images. The selection of the previous health images to use to generate the combined previous health image may be based on various factors, such as time of execution, type of execution, and/or the like.

In some embodiments, the method includes identifying at least one of the one or more previous component health images for the component based on a similarity to the component health image. The system may query a database with a plurality of previous component health images and select one or more based on the similarities to the component health image being analyzed. Additionally, the method may include generating an array of one or more component metric images. The array of the one or more component metric images is used to generate at least one of the one or more previous component health images for the component.

In various embodiments, the system may be configured to modify at least one of the one or more previous component health images for the component to conform to a format of the component health image of the component. For example, the component health image generated and/or received in Block 1002 and 1004 of the method may be a different format than one or more of the previous component health images. In such an instance, one or more both of the component health image and the previous component health image(s) may be modified to a standard format for analysis. The standard format may be based on the format of the component health image being analyzed.

Referring now to Block 1008 of FIG. 10, the method includes determining a component health image similarity score based on the comparison of the component health image based on the execution of the process to the one or more previous component health images for the component based on one or more previous executions of the process.

The component health image similarity score may be generated using a similarity searching tool, such as a cosine similarity, an L2 normalization, or approximate nearest neighbors oh yeah (“ANNOY”). The component health image similarity score may be standardized, such that a number outside of a threshold range may be considered anomalous. For example, the component health image similarity score may be produced via a standard distribution of the one or more previous component health images for the component.

Referring now to Block 1010 of FIG. 10, the method includes determining a component health action based on the component health image similarity score. The component health action may include causing a transmission of an alert in an instance in which the component health image similarity score is outside of a threshold range. The transmission may indicate a potential anomaly, the severity of the potential anomaly, the affected component, the executed process, and/or other information that may be used to correct the anomaly. Additional other actions may be taken, such as an automated check-up of the component for potential errors or issues.

As will be appreciated by one of ordinary skill in the art, various embodiments of the present disclosure may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present disclosure may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present disclosure may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present disclosure, however, the computer-readable medium may be transitory, such as a propagation signal including computer-executable program code portions embodied therein.

It will also be understood that one or more computer-executable program code portions for carrying out the specialized operations of the present disclosure may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present disclosure are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present disclosure are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present disclosure.

While certain example embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the disclosure. Therefore, it is to be understood that, within the scope of the appended claims, the disclosure may be practiced other than as specifically described herein.

What is claimed is:

1. A system for analyzing system health of individual electronic components using image mapping, the system comprising:
at least one non-transitory storage device; and
at least one processing device coupled to the at least one non-transitory storage device, wherein the at least one processing device is configured to:
receive a component health image for a component based on an execution of a process;
compare the component health image based on the execution of the process to one or more previous component health images for the component based on one or more previous executions of the process;
based on the comparison of the component health image based on the execution of the process to the one or more previous component health images for the component based on one or more previous executions of the process, determine a component health image similarity score; and
based on the component health image similarity score, determine a component health action, wherein the component health action comprises causing a transmission of an alert in an instance in which the component health image similarity score is outside of a threshold range.

2. The system of claim 1, wherein the comparison of the component health image based on the execution of the process to the one or more previous component health images for the component based on one or more previous executions of the process comprises comparing the component health image to an average component health image based at least partially on the one or more previous component health images.

3. The system of claim 1, wherein the component health image similarity score is produced via a standard distribution of the one or more previous component health images for the component.

4. The system of claim 1, wherein the at least one processing device is configured to modify at least one of the one or more previous component health images for the component to conform to a format of the component health image of the component.

5. The system of claim 1, wherein the at least one processing device is configured to identify at least one of the one or more previous component health images for the component based on a similarity to the component health image.

6. The system of claim 1, wherein the at least one processing device is configured to generate an array of one or more component metric images, wherein the array of the one or more component metric images is used to generate at least one of the one or more previous component health images for the component.

7. The system of claim 1, wherein the at least one processing device is configured to generate the component health image for the component based on the execution of the process.

8. A computer program product for analyzing system health of individual electronic components using image mapping, the computer program product comprising at least one non-transitory computer-readable medium having computer-readable program code portions embodied therein, the computer-readable program code portions comprising:
an executable portion configured to receive a component health image for a component based on an execution of a process;
an executable portion configured to compare the component health image based on the execution of the process to one or more previous component health images for the component based on one or more previous executions of the process;
an executable portion configured to determine a component health image similarity score based on the comparison of the component health image based on the execution of the process to the one or more previous component health images for the component based on one or more previous executions of the process; and
an executable portion configured to determine a component health action based on the component health image similarity score, wherein the component health action comprises causing a transmission of an alert in an instance in which the component health image similarity score is outside of a threshold range.

9. The computer program product of claim 8, wherein the comparison of the component health image based on the execution of the process to the one or more previous component health images for the component based on one or more previous executions of the process comprises comparing the component health image to an average component health image based at least partially on the one or more previous component health images.

10. The computer program product of claim 8, wherein the component health image similarity score is produced via a standard distribution of the one or more previous component health images for the component.

11. The computer program product of claim 8, wherein the computer program product further comprises an executable portion configured to modify at least one of the one or more previous component health images for the component to conform to a format of the component health image of the component.

12. The computer program product of claim 8, wherein the computer program product further comprises an executable portion configured to identify at least one of the one or more previous component health images for the component based on a similarity to the component health image.

13. The computer program product of claim 8, wherein the computer program product further comprises an executable portion configured to generate an array of one or more component metric images, wherein the array of the one or more component metric images is used to generate at least one of the one or more previous component health images for the component.

14. The computer program product of claim 8, wherein the computer program product further comprises an executable portion configured to generate the component health image for the component based on the execution of the process.

15. A computer-implemented method for analyzing system health of individual electronic components using image mapping, the method comprising:
receiving a component health image for a component based on an execution of a process;
comparing the component health image based on the execution of the process to one or more previous component health images for the component based on one or more previous executions of the process;
determining a component health image similarity score based on the comparison of the component health image based on the execution of the process to the one or more previous component health images for the component based on one or more previous executions of the process; and
determining a component health action based on the component health image similarity score, wherein the component health action comprises causing a transmission of an alert in an instance in which the component health image similarity score is outside of a threshold range.

16. The method of claim 15, wherein the comparison of the component health image based on the execution of the process to the one or more previous component health images for the component based on one or more previous executions of the process comprises comparing the component health image to an average component health image based at least partially on the one or more previous component health images.

17. The method of claim 15, wherein the component health image similarity score is produced via a standard distribution of the one or more previous component health images for the component.

18. The method of claim 15, further comprising identifying at least one of the one or more previous component health images for the component based on a similarity to the component health image.

19. The method of claim 15, further comprising generating an array of one or more component metric images, wherein the array of the one or more component metric images is used to generate at least one of the one or more previous component health images for the component.

20. The method of claim 15, further comprising generating the component health image for the component based on the execution of the process.
